(19) United States
(12) Patent Application Publication
(10) Pub. No.: US 2014/0032774 A1
(43) Pub. Date: Jan. 30, 2014

(54) Client-emulating Gateways for Communication Network Migration

(71) Applicants: Bruce B. Lowekamp, Williamsburg, VA (US); Magnus Hiie, Los Altos (CA)

(72) Inventors: Bruce B. Lowekamp, Williamsburg, VA (US); Magnus Hiie, Los Altos (CA)

(73) Assignee: Microsoft Corporation, Redmond, WA (US)

(21) Appl. No.: 13/561,979

(22) Filed: Jul. 30, 2012

(51) Int. Cl. G06F 15/16

(52) U.S. Cl. 709/230

(57) ABSTRACT

A client-emulating gateway is configured to emulate a first client that communicates using a first protocol. The client-emulating gateway receives communications from a second client in accordance with a second, different protocol used for communicating by the second client. The client-emulating gateway translates the communications from the second, different protocol to the first protocol to provide translated communications. The translated communications are then sent to the first client using the first protocol. Communications that are received back from the first client in the first protocol are then translated into the second, different protocol and then sent to the second client.

### BACKGROUND

Many computer users typically belong to a communications network through which they can be contacted and contact others. This network may take the form of an internal corporate instant messaging (IM) system, Internet email, corporate internal private branch exchange (PBX) phone system, the international public switched telephone network (PSTN), and the like. For many of these, there may be multiple versions of these networks, although there is only one international PSTN. That is, there are many corporate internal PBX systems and there are numerous online voice and video calling networks operated by different providers. These networks can and often do use different protocols to communicate.

As a communications network's value is frequently expressed in terms of the number of users who can be contacted, operators frequently desire to establish connections between networks so that users of one network may contact those in another. This is frequently referred to as “bridging” or “peering” two networks. In other situations, an operator may wish to migrate from one network to another to move all users of the network to a new networking technology or to merge two networks into a single network. However, if an instant migration path is not provided between networks, there is either downtime (e.g., “the office phone system will be unavailable this week while our contractor upgrades our system”) or a need to maintain both networks during the migration period. In effect, this is bridging a network to provide a smooth migration path without allowing users to observe that there are actually two separate networks.

For a server-based network where all clients connect directly to the server and exchange all commands, control, and communication media with the server, an operator can continue to communicate using the same network protocol with the old clients, and translate the protocol inside the new server. However, for clients that perform control signaling, exchange media, and the like, directly with other clients (e.g., end-to-end or peer-to-peer), a convenient server-side change is not necessarily possible. If such a non-upgraded client is to be bridged to the new network, the conventional solution is to require the “new” clients to also speak the old protocol. If this is not possible, then the non-upgraded clients cannot speak with the new network clients, and bridging is not possible.

### SUMMARY

This Summary is provided to introduce a selection of concepts in a simplified form that are further described below in the Detailed Description. This Summary is not intended to identify key features or essential features of the claimed subject matter.

Various embodiments provide a client-emulating gateway that is configured to emulate a first client that communicates using a first protocol. The client-emulating gateway receives communications from a second client in accordance with a second, different protocol used for communicating by the second client. The client-emulating gateway then translates the communications from the second, different protocol to the first protocol to provide translated communications. The translated communications are then sent to the first client using the first protocol. Communications that are received back from the first client in the first protocol are then translated into the second, different protocol and then sent to the second client.

In at least some embodiments, scalability is promoted by utilizing a distributed client-emulating gateway. In these embodiments, various functionality utilized by clients to communicate is distributed and run separately. By distributing functionality, information and data that is not utilized in a current communication can be stored and reloaded, as necessary, when needed for a particular communication.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 illustrates an example client architecture in accordance with one or more embodiments.

FIG. 3 illustrates an example client-emulating gateway in accordance with one or more embodiments.

FIG. 4 illustrates an example client-emulating gateway in accordance with one or more embodiments.

FIG. 5 illustrates an example client-emulating gateway in accordance with one or more embodiments.

FIG. 6 illustrates operation of an example client-emulating gateway in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 illustrates an example system that includes the various end user terminals as described with reference to FIG. 1.

### DETAILED DESCRIPTION

Overview

Various embodiments provide a client-emulating gateway that is configured to emulate a first client that communicates using a first protocol. The client-emulating gateway receives communications from a second client in accordance with a second, different protocol used for communicating by the second client. The client-emulating gateway then translates the communications from the second, different protocol to the first protocol to provide translated communications. The translated communications are then sent to the first client using the first protocol. Communications that are received back from the first client in the first protocol are then translated into the second, different protocol and then sent to the second client.

In various embodiments, one of the sides participating in a call can communicate using a server-based protocol and the gateway interacts with the server rather than the client on that side. In at least some of these embodiments, the server can perform such functions as locating users and relaying the signaling and associated media. In these instances, the gateway may act as a client when it communicates with the server or it may communicate using a server to server version of the protocol. For example, Alice may call Bob. In some instances, the gateway impersonates a client of Alice on the second network and signals the server that she is calling Bob. Alternately, the gateway may have a server-to-server protocol that it uses and signals the server that Alice is calling Bob without any impersonation. From this point on, the call may take place directly between Alice and Bob, or it may be relayed through the gateway and/or server in the second network.

In addition, it may also be possible for the calling clients to utilize the same protocol, but only some of the time. For example, Alice's client may utilize a first protocol and Bob's clients may use both the first protocol and a second protocol. In some operating modes, Bob may communicate using just the second and not the first protocol. When Alice calls Bob, her protocol signals on the first protocol. In this case, the gateway receives the call using the first protocol and forwards the notification to Bob via the servers for the second protocol which, in turn, relay the call to Bob's client. Bob's client then wakes up and completes the call using the first protocol.

In at least some embodiments, scalability is promoted by utilizing a distributed client-emulating gateway. In these embodiments, various functionality utilized by clients to communicate is distributed and run separately. By distributing functionality, information and data that is not utilized in a current communication can be stored and reloaded, as necessary, when needed for a particular communication.

In operation, the client-emulating gateway can include a number of different features to promote communication between networks that utilize different protocols. For example, the client-emulating gateway can be configured to authenticate itself as the actual clients that it is emulating. This can take place using a variety of mechanisms including, by way of example and not limitation, using a shared secret, a public key process, and the like. The client-emulating gateway can also be reachable by way of the same mechanism utilized by clients in their networks, e.g., a TCP ip:port address. The client-emulating gateway can also maintain sufficient state, as appropriate, to emulate a particular client. For example, if a particular emulated network client would be knowledgeable about previous connections or information exchange, then the client-emulating gateway can maintain state associated with this information. The client-emulating gateway can thus forward communication information being exchanged with a different network that utilizes a different protocol. In this manner, the sending client believes it is communicating with the receiving client utilizing the same protocol that the sending client uses. The client-emulating gateway may also be able to co-exist with other clients of the same user in their particular network. In particular, if a client is configured to use different networks having different protocols, the client-emulating gateway can emulate the client, both when it uses each different network protocol.

In the discussion that follows, a section entitled “Example Environment” describes an example environment in which the various embodiments can be utilized. Next, a section entitled “Client Emulating Gateway Embodiments” describes various embodiments of a client-emulating gateway. Following this, a section entitled “Example Methods” describes example methods in accordance with one or more embodiments. Last, a section entitled “Example System” describes an example system and various devices that can be utilized to implement one or more embodiments.

Consider now an example environment in which various embodiments can be practiced.

### Example Environment

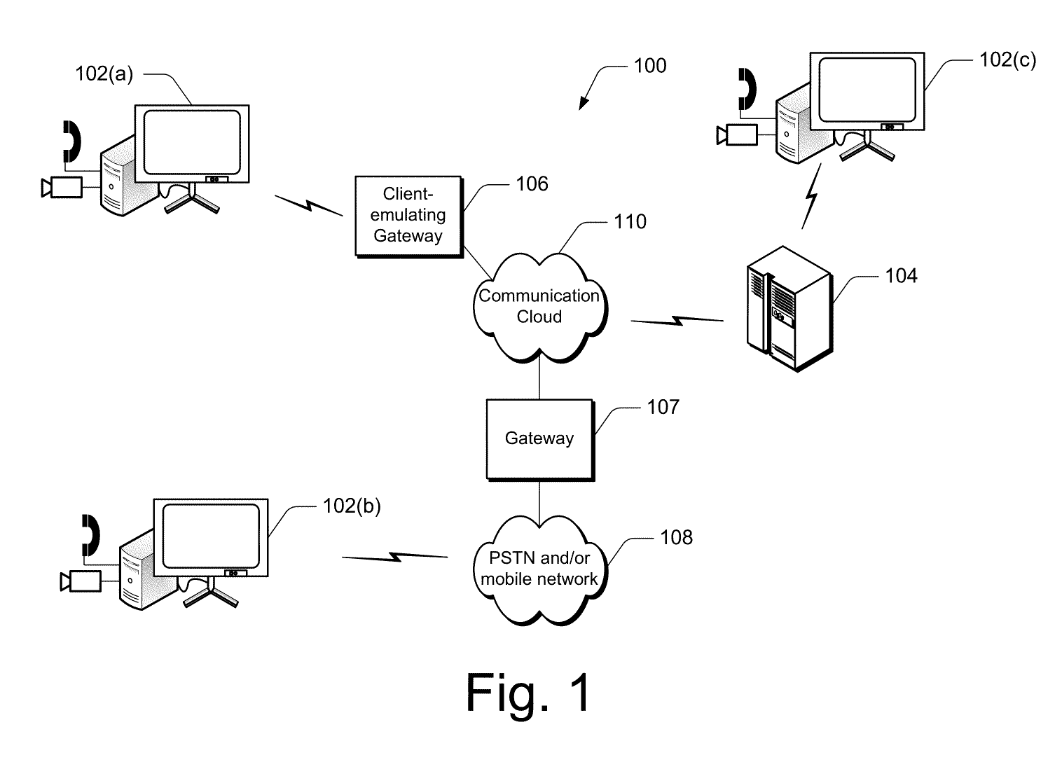

FIG. 1 is a schematic illustration of a communication system 100 which, in at least some embodiments, can be implemented over a packet-based network, here represented by communication cloud 110 in the form of the Internet, comprising a plurality of interconnected elements. In this example, each network element may be connected to the rest of the Internet, and is configured to communicate data with other such elements over the Internet by transmitting and receiving data in the form of Internet Protocol (IP) packets. Alternately or additionally, networks other than the Internet can be utilized. For example, PSTN can route calls via non-IP protocols. In addition, calling can take place within private networks rather than the Internet. In at least some embodiments, each element also has an associated IP address locating it within the Internet, and each packet includes a source and destination IP address in its header. The elements shown in FIG. 1 include a plurality of end-user terminals 102(a), 102(b), and 102(c) such as desktop or laptop PCs or Internet-enabled mobile phones, a server 104, such as a peer-to-peer server of an Internet-based communication system or a traditional server configured to enable client/server communication, a client-emulating gateway 106 that operates as described above and below, and a gateway 107 to another type of network 108, such as to a traditional Public-Switched Telephone Network (PSTN) or other circuit switched network, and/or to a mobile cellular network. However, it will of course be appreciated that many more elements make up the Internet than those explicitly shown. This is represented schematically in FIG. 1 by the communications cloud 110 which typically includes many other end-user terminals, servers and gateways, as well as routers of Internet service providers (ISPs) and Internet backbone routers.

In various embodiments, the client-emulating gateway 106 is configured to emulate a first client that communicates using a first protocol. For example, the client-emulating gateway 106 may emulate clients executing on each of end-user terminals 102(a), 102(b) and 102(c) for purposes of enabling communication with other clients or servers that utilize different communication protocols. The client-emulating gateway 106 receives communications from a second client in accordance with a second, different protocol used for communicating by the second client. The client-emulating gateway then translates the communications from the second, different protocol to the first protocol to provide translated communications. The translated communications are then sent to the first client, using the first protocol. Communications that are received back from the first client in the first protocol are then translated into the second, different protocol and then sent to the second client.

Assume that each of end-user terminals 102(a), 102(b), and 102(c) communicates using a different protocol. Assume also that a client on end-user terminal 102(a) transmits a communication to a client on end-user terminal 102(b). The transmitted communication is in accordance with a protocol utilized by the client on end-user terminal 102(a). The client-emulating gateway and, more specifically, an emulated client of a client executing on end-user terminal 102(b) receives the communication and translates the communication into the protocol associated with the client executing on end-user terminal 102(b). The translated communication is then sent to the client executing on end-user terminal 102(b). Communications that are received back from the client executing on end-user terminal 102(b) are received by the client-emulating gateway and, more specifically, by an emulated client of the client executing on end-user terminal 102(a). The communications are then translated back into the protocol associated with the client executing on end-user terminal 102(a) and sent to that client. Translation of the communications can take place in any suitable number of ways, examples of which are provided below.

In at least some embodiments, scalability is promoted by utilizing a distributed client-emulating gateway, described below in more detail. In these embodiments, various functionality utilized by clients to communicate is distributed and run separately. By distributing functionality, information and data that is not utilized in a current communication can be stored and reloaded, as necessary, when needed for a particular communication.

In the illustrated and described embodiment, end-user terminals 102(a) to 102(c) can communicate with one another, as well as other entities, by way of the communication cloud using any suitable techniques. Thus, end-user terminals can communicate through the communication cloud 110, through the communication cloud 110, gateway 107 and network 108, or through server 104 using, for example Voice over IP (VOIP). In addition, the client-emulating gateway 106 can be located at any suitable location within the system shown in FIG. 1.

In at least some instances, in order to communicate with another end user terminal, a client executing on an initiating end user terminal acquires the IP address of the terminal on which another client is installed. This can be done using an address look-up or any suitable technique.

Some Internet-based communication systems are managed by an operator, in that they rely on one or more centralized, operator-run servers for address look-up (not shown). In that case, when one client is to communicate with another, then the initiating client contacts a centralized server run by the system operator to obtain the callee's IP address. Other approaches can be utilized. For example, in some server-based systems, call requests are received by the server and media is relayed by the server. In this instance, there is not an end-to-end connection between the clients, but rather a server in between for the communication that takes place.

In contrast to these operator managed systems, another type of Internet-based communication system is known as a “peer-to-peer” (P2P) system. Peer-to-peer (P2P) systems typically devolve responsibility away from centralized operator servers and into the end-users' own terminals. This means that responsibility for address look-up is devolved to end-user terminals like those labeled 102(a) to 102(c). Each end user terminal can run a P2P client application, and each such terminal forms a node of the P2P system. P2P address look-up works by distributing a database of IP addresses amongst some of the end user nodes. The database is a list which maps the usernames of all online or recently online users to the relevant IP addresses, such that the IP address can be determined given the username. The above constitutes but an example only. It is to be appreciated and understood that other approaches can be utilized without departing from the spirit and scope of the claimed subject matter. For example, some systems can utilize multiple IP addresses or utilize URIs which have DNS names.

Once known, the address allows a user to establish a voice or video call, or send an instant message (IM) chat message or file transfer, etc. Additionally however, the address may also be used when the client itself needs to autonomously communicate information with another client.

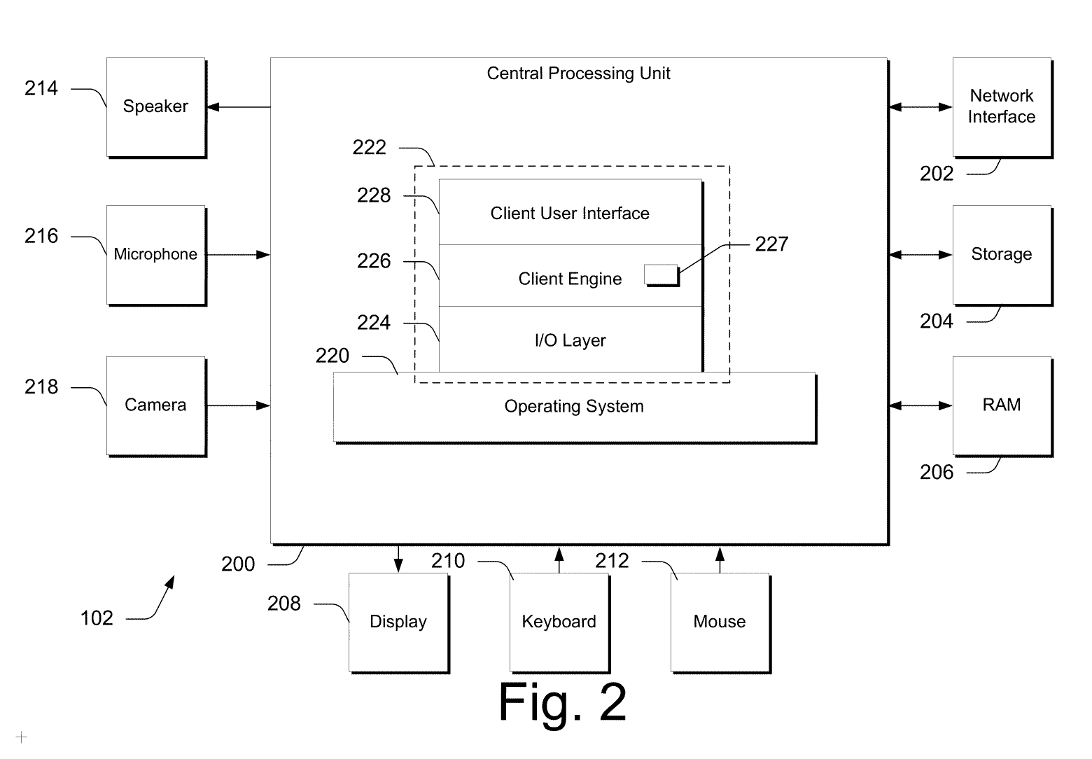

The schematic block diagram of FIG. 2 shows an example of an end-user terminal 102 which is configured to act as a terminal of a system operating over the Internet. The system may comprise a P2P system and/or a non-P2P system and may use one or more different protocols to communicate. The terminal 102 comprises a processor or CPU 200 operatively coupled to: a network interface 202 such as modem or other interface for connecting to the Internet, a non-volatile storage device 204 such as a hard-drive or flash memory, and a volatile memory device such as a random access memory (RAM) 206. The terminal 102 also comprises one or more user input devices, for example in the form of a keyboard or keypad 210, a mouse 212, a microphone 216 and a camera 218 such as a webcam, each operatively coupled to the CPU 200. The terminal 102 further comprises one or more user output devices, for example in the form of a display 208 and speaker 214, again each operatively coupled to the CPU 200.

The storage device 204 stores software including at least an operating system (OS) 220, and packet-based communication software in the form of a client application 222 which may comprise a P2P application and/or a non-P2P application through which communication can take place over a network, such as the networks described in FIG. 1. On start-up or reset of the terminal 102, the operating system 220 is automatically loaded into the RAM 206 and from there is run by being executed on the CPU 200. Once running, the operating system 220 can then run applications, such as the client application 222, by loading them into the into the RAM 206 and executing them on the CPU 200. To represent this schematically in FIG. 2, the operating system 220 and client application 222 are shown within the CPU 200.

In this particular non-limiting example, the client application 222 comprises a “stack” having three basic layers: an input and output (I/O) layer 224, a client engine layer 226, and a client user interface (UI) layer 228. The functionality of these layers can be implemented by an architecture other than the one specifically depicted without departing from the spirit and scope of the claimed subject matter.

Each layer or corresponding functionality module is responsible for specific functions. Because each successive layer usually communicates with two adjacent layers (or one in the case of the top layer), they are regarded as being arranged in a stack as shown in FIG. 2. The client application 222 is said to be run “on” the operating system 220. This means that in a multi-tasking environment it is scheduled for execution by the operating system 220; and further that inputs to the lowest (I/O) layer 224 of the client application 222 from network interface 202, microphone 216 and camera 218 as well as outputs from the I/O layer 224 to network interface 202, display 208 and speaker 214 may be mediated via suitable drivers and/or APIs of the operating system 220. In at least some embodiments, the client application 222 can be implemented to include a web-based interface that can be utilized to present audiovisual and interactive content.

The I/O layer 224 of the client application comprises a voice engine and optionally a video engine in the form of audio and video codecs which receive incoming encoded streams and decodes them for output to speaker 214 and/or display 208 as appropriate, and which receive unencoded audio and/or video data from the microphone 216 and/or camera 218 and encodes them for transmission as streams to other end-user terminals 102 of a P2P system, or other entities in a PSTN and/or mobile network such as network 108. The I/O layer 224 may also comprise a control signaling protocol for signaling control information between terminals 102 of the network.

The client engine layer 226 then handles the connection management functions of the system as discussed above, such as establishing calls or other connections by P2P address look-up and authentication, as well as by other techniques. The client engine may also be responsible for other secondary functions of the system such as supplying up-to-date contact lists and/or avatar images of the user to the server 104 (FIG. 1); or retrieving up-to-date contact lists of the user and retrieving up-to-date avatar images of other users from the server 104.

The client user interface layer 228 is responsible for presenting decoded content, such as audiovisual and/or interactive content to the user via the display 208, for presenting the output on the display 208 along with other information such as presence and profile information and user controls such as buttons and menus, and for receiving inputs from the user via the presented controls.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the end user terminal 102 may also include an entity (e.g., software) that causes hardware or virtual machines of the end user terminal 102 to perform operations, e.g., processors, functional blocks, and so on. For example, the end user terminal 102 may include a computer-readable medium that may be configured to maintain instructions that cause the end user terminal, and more particularly the operating system and associated hardware of the end user terminal 102 to perform operations. Thus, the instructions function to configure the operating system and associated hardware to perform the operations and in this way result in transformation of the operating system and associated hardware to perform functions. The instructions may be provided by the computer-readable medium to the end user terminal 102 through a variety of different configurations.

One such configuration of a computer-readable medium is signal bearing medium and thus is configured to transmit the instructions (e.g., as a carrier wave) to the end user terminal, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having considered an example operating environment in accordance with one or more embodiments, consider now a discussion of various client-emulating gateways in accordance with one or more embodiments.

### Client Emulating Gateway Embodiments

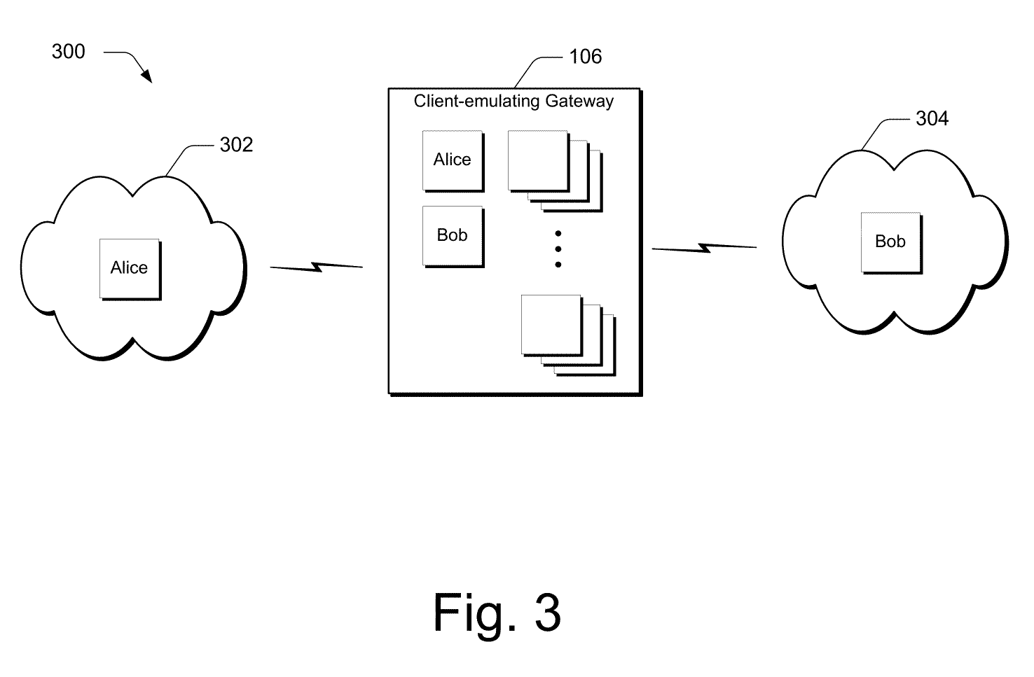

FIG. 3 illustrates an example system in accordance with one or more embodiments, generally at 300. In this example, system 300 includes a first network 302 utilizing a first protocol for communication, a second network 304 utilizing a second different protocol for communication, and a client-emulating gateway 106. The first network 302 includes a user “Alice” executing a client that utilizes the first protocol for communicating. The second network 304 includes a user “Bob” executing a client that utilizes the second protocol for communicating.

For purposes of example only, consider that the first protocol is the Skype protocol and that the second protocol is the Microsoft Notification Protocol (MSNP). The Skype protocol is a proprietary Internet telephony network based on peer-to-peer architecture used by Skype.

In this example, the client-emulating gateway 106 includes a large number of copies of the actual client software that each particular user is executing on their end-user terminal. The client-emulating gateway essentially emulates the devices of thousands of clients. In this instance, the client-emulating gateway performs bridging based on user-interface level interactions of the client software.

As an example, consider the following. Assume that Alice wishes to place a peer-to-peer call to Bob. When she places the call using her Skype client, Bob's emulated client on the client-emulating gateway receives the call (i.e., “Alice is calling”). Data associated with the call is processed and translated and a call is placed to Bob in network 304 using his protocol (MSNP). Specifically, the audio packets that are received from Alice can be processed into audio data and converted back into packets that are in compliance with Bob's protocol. Subsequent communication from Bob to Alice is received by Alice's emulated client, processed and translated, and then sent to Alice's client in network 302. In this example, Alice's experience is that she placed a Skype call and had her call completed. Bob's experience is that he received a call in his network's protocol, i.e. MSNP, and was able to communicate with Alice. Each user is essentially unaware of the translation that takes place. That is, by virtue of the client-emulating gateway, it appears to the users that they simply participated in a call using their own systems in accordance with their particular protocols.

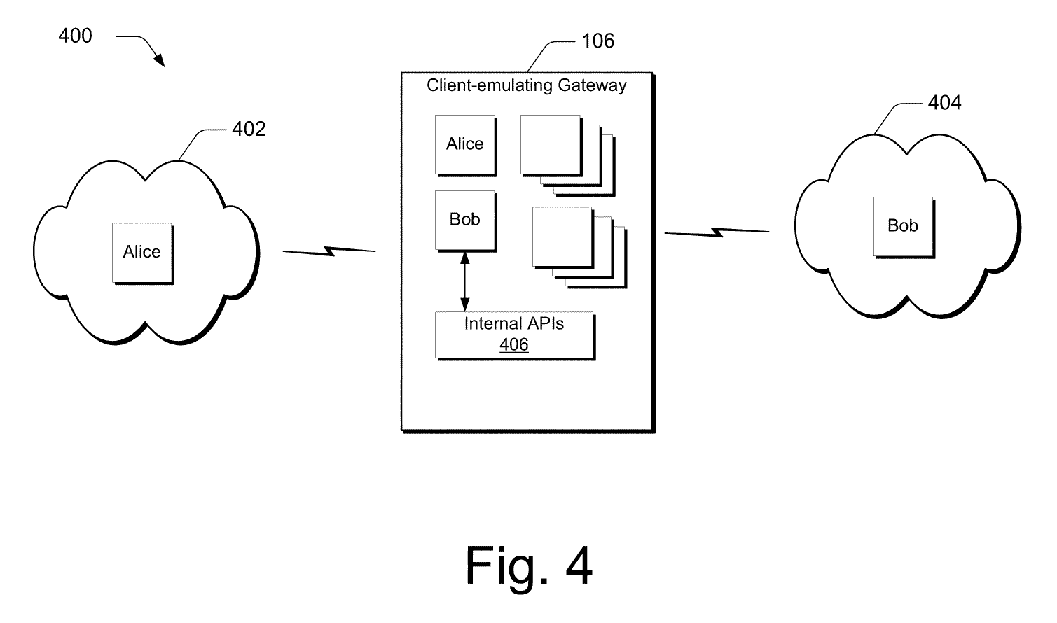

FIG. 4 illustrates an example system in accordance with another embodiment, generally at 400. In this example, system 400 includes a first network 402 utilizing a first protocol for communication, a second network 404 utilizing a second different protocol for communication, and a client-emulating gateway 106. The first network 402 again includes user “Alice” executing a client that utilizes the first protocol for communicating. The second network 304 again includes user “Bob” executing a client that utilizes the second protocol for communicating.

For purposes of example only, consider that the first protocol is the Skype protocol and that the second protocol is the Microsoft Notification Protocol (MSNP). In this example, the client-emulating gateway 106 includes a large number of copies of the actual client software that each particular user is executing on their end-user terminal. The client-emulating gateway essentially emulates the devices of thousands of clients. In this instance, the emulated clients on the client-emulating gateway have been designed to provide full controllability via an Application Program Interfaces (APIs) 406 which provide equivalent control to that provided by the user-interface as detailed in the previous embodiment. These APIs are configured to perform protocol-based translations and connect calls between clients that communicate using different protocols.

As an example, consider the following. Assume that Alice wishes to place a peer-to-peer call to Bob. When she places the call using her Skype client, a function call is made from Alice's client and Bob's emulated client on the client-emulating gateway receives the function call. Bob's emulated client then utilizes the internal APIs 406 to complete the call to Bob. Specifically, the internal APIs can be utilized such that data associated with the call is processed and translated and a call is placed to Bob in network 404 using his protocol (MSNP). Subsequent communication from Bob to Alice would be received by Alice's emulated client, processed and translated by the internal APIs 406, and then sent to Alice's client in network 402. In this example, Alice's experience is that she placed a Skype call and had her call completed. Bob's experience is that he received a call in his network's protocol, i.e. MSNP, and was able to communicate with Alice.

Again, it is to be appreciated and understood that while protocol examples of the Skype protocol and MSNP have been used, this is for example purposes only. Other different protocols can be utilized without departing from the spirit and scope of the claimed subject matter. Such protocols can include, by way of example and not limitation, SIP, Jingle/XMPP, or Reload/P2PSIP. Further, because these various different protocols may have different individual nuances and operating characteristics, the translation aspects implemented by the client-emulating gateway will vary as between protocols. In addition, while the example above utilized a call for the purpose of illustration, these techniques can be applied to other communication instances such as instant messaging and the like. This is the case for all of the described embodiments.

Both of the above-described approaches can work adequately for a small network, such as a communication network for a small business. However, these approaches can utilize tremendous resources, e.g., thousands of servers, to serve the needs of a large-scale network. To adapt the client-emulating gateway approach to a larger-scale network, an efficient approach is to divide the responsibilities of a single monolithic client into multiple parts. For example, consider an implementation of a communication network offering presence (or availability) indications, instant message (IM) exchange, and audio/video calling between clients. In at least some embodiments, scalability is promoted by utilizing a distributed client-emulating gateway. In these embodiments, various functionality that is utilized by clients to communicate is distributed and run separately. By distributing functionality, information and data that is not utilized in a current communication can be stored and reloaded, as necessary, when needed for a particular communication.

As but one example, consider that the functionality in such a client might be divided or distributed as follows: network transport, session state, presence, instant messaging, calling, and media.

The functionality associated with network transport pertains to enabling the client to send and receive network protocol messages (e.g., a TCP/IP socket with XML messages). The functionality associated with session state pertains to maintaining the state of current connections with other clients. The functionality associated with presence pertains to maintaining a client's presence and exchanging information with other clients to learn their presence by way of the session and network transport components. The functionality associated with instant messaging pertains to maintaining a list of current chats and/or archives of previous chats, sending messages initiated by the client and receiving messages sent by other clients. In addition, this functionality can include forwarding these messages cooperatively between multiple clients in the network. The functionality associated with calling pertains to call placement, initial setup, and call signaling (e.g., hold and the like) and involves communicating call state with other clients of both the same and/or different users in the call. The functionality associated with media pertains to the exchange of various types of media including, by way of example and not limitation, audio/visual and other media during a call.

As background, a traditional monolithic peer-to-peer client typically implements all of these functionalities. In a typical implementation, components associated with each of these functionalities are loaded, initialized, and ready to send/receive commands continuously during client execution. However, in a client-emulating gateway, it may not be necessary to allocate all of these resources or components for every user that may need to be bridged between networks.

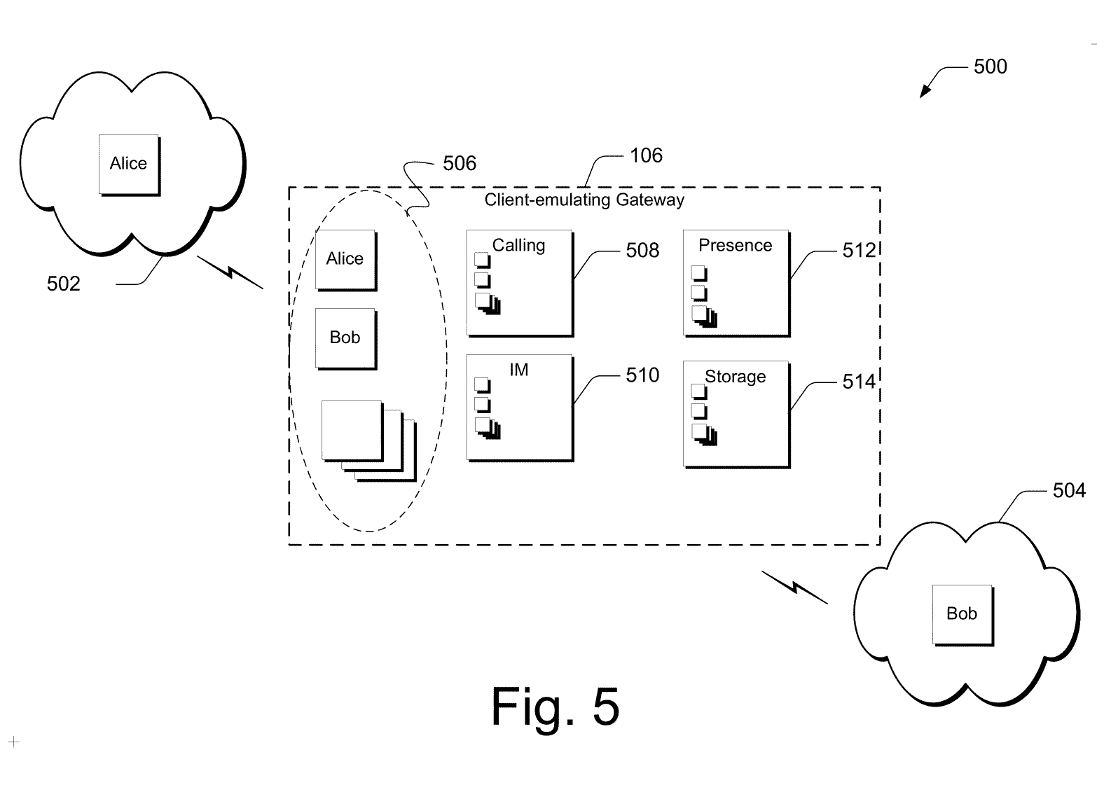

Instead, in one or more embodiments, a distributed client-emulating gateway is utilized which, to a non-upgraded client in an original network (e.g., P2P network) behaves identically to a regular client. However, in this instance, the components of the client-emulating gateway and their associated functionality are distributed and are run separately, as appropriate. Hence, information that is not currently needed for communication can be stored via a local or distributed storage system, such as disk-based storage, that allows the information to be reloaded as needed for actual communication, but otherwise retains that state in extremely inexpensive storage. Accordingly, the design of the distributed client-emulating gateway allows the gateway to expend resources proportional to the amount of actual communication between bridged users, rather than proportional to the potential user-base of the bridged networks. This can result in orders of magnitude less resources being utilized for the gateway than the previously-described embodiments. As an example, consider FIG. 5.

There, an example system in accordance with one or more embodiments is shown, generally at 500. In this particular example, system 500 includes a first network 502 utilizing a first protocol for communication, a second network 504 utilizing a second different protocol for communication, and a client-emulating gateway 106. As in the above example, the first network 502 includes a user “Alice” executing a client that utilizes the first protocol for communicating. The second network 504 includes a user “Bob” executing a client that utilizes the second protocol for communicating.

For purposes of example only, consider that the first protocol is the Skype protocol and that the second protocol is the Microsoft Notification Protocol (MSNP).

In this example, the client-emulating gateway 106 includes functionality that has been distributed to include the following components: a network transport 506, a calling component 508, an instant messaging (IM) component 510, a presence component 512, and a storage component 514.

In the illustrated and described embodiment, the client emulating gateway 106 separates its network transport from the other components. If the client-emulating gateway 106 is performing no current functions on behalf of the user (i.e. functionality other than network functionality is not being utilized), then simply the network transport 506 can allocated and utilized to provide an ability to receive an incoming connection from a client that wishes to interact with the emulated user.

In one or more embodiments, the session state component, mentioned above earlier, may be part of the network transport 506. Alternately, the session state component can be implemented separately. If state from previous connections between clients is to be preserved, the state may be preserved via a local or distributed storage system, such as storage component 514.

The functionalities of presence, instant messaging (IM), calling, and media share a common advantage in that they consume no resources on the system until they are required to be loaded. One or more servers may be dedicated exclusively to running each functionality as a single service. When the functionality is loaded, the per-user state is greatly reduced as compared with the earlier-described embodiments because, written as a server-based component, users of that component share a common infrastructure, and only the actual details utilized for a particular user (such as their current presence status and the status of their buddies) actually consume resources. Currently unneeded resources (such as an archive of previous IM messages) may be preserved via a local or distributed storage system.

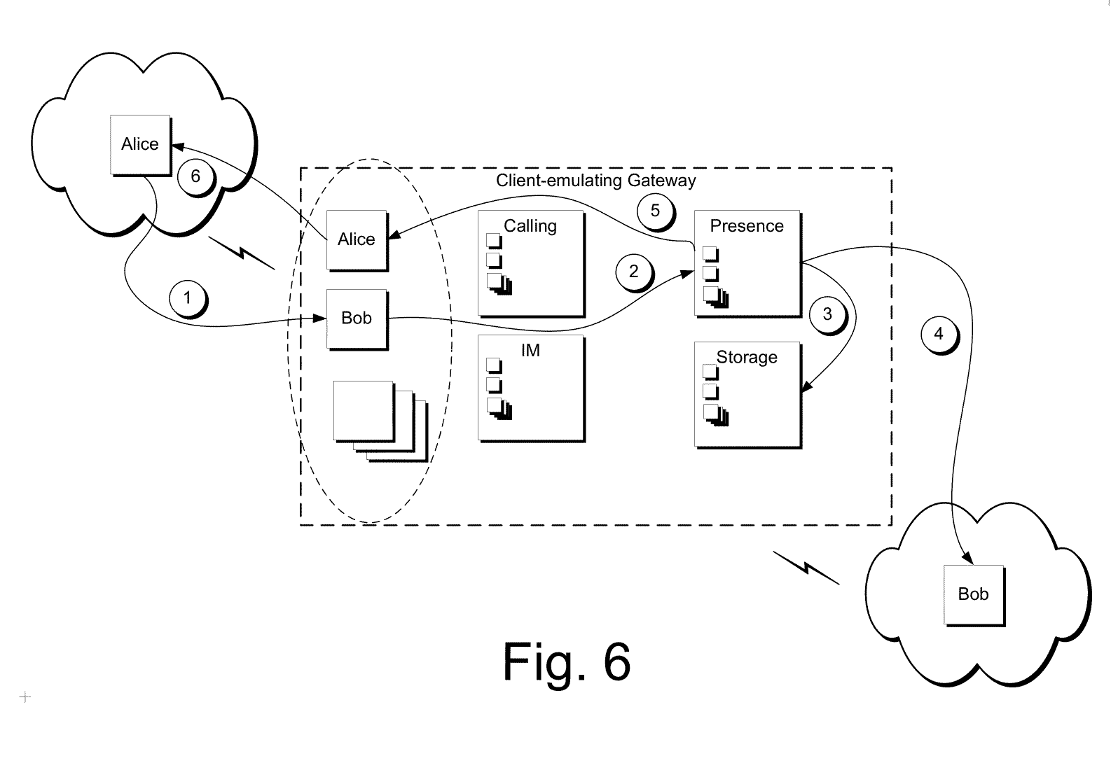

As an example of how such a system might work, consider FIG. 6 and users Alice and Bob. Components from FIG. 5 have been utilized with their specific numerical designators being eliminated for the purpose of illustrating the process flow more clearly.

Alice resides on a P2P network and Bob resides on a new network different from the P2P network. In this P2P network, when a client comes online, it sends a message to each of their buddies announcing their online status.

The client-emulating gateway maintains a network transport (illustrated by the dashed ellipse) that is ready to receive messages for Alice or Bob at all times.

When Alice comes online, she sends her online status, at “1”, to all “Bobs” she finds. One of the “Bobs” happens to be on the client-emulating gateway. The network transport receives the online status, identifies the online status as a presence message, and forwards the presence message, at “2”, to the server cluster responsible for presence functionality. The network transport indicates that the presence message was received by Bob from Alice.

The presence functionality pulls, from stable storage at “3”, information that is utilized to act on behalf of Bob.

Bob is determined to be online in the new network. Accordingly, the presence functionality emulates Alice's online state to Bob in the new network at “4”, and sends a response on behalf of Bob via the network transport in the old network at “5” which is then provided to Alice's client at “6”, thus providing Bob's presence as if he were on the old network.

In one or more embodiments, the presence functionality may store Bob's knowledge of Alice's presence state in stable storage. At that point, the presence functionality need not maintain further state for either user, although it may cache such information for performance reasons. Note that the use of stable storage allows incoming messages to the presence functionality to be routed to any available presence server. Although to improve performance by caching, routing affinity can be provided to ensure messages for Bob are delivered to the same server.

In this example, translation aspects of communications that take place between clients using different protocols can be performed by each of the components as appropriate. For example, in the case of a call, call translation can be performed by the calling component. In the case of an instant message, translation can be performed by the IM component and so on.

Having considered various embodiments, consider now example methods in accordance with one or more embodiments.

### Example Methods

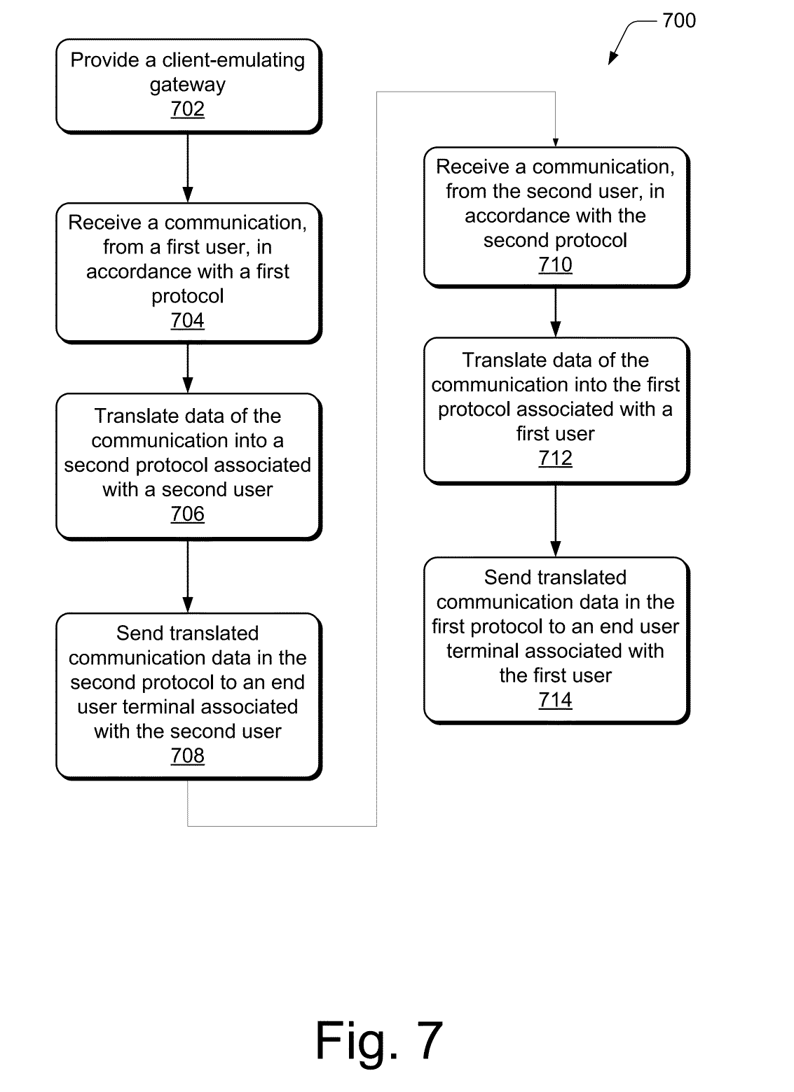

FIG. 7 illustrates a method 700 in accordance with one or more embodiments. The method can be implemented in connection with any suitable hardware, software, firmware, or combination thereof. In at least some embodiments, the method can be implemented by a suitably-configured client-emulating gateway, as described above.

Step 702 provides a client-emulating gateway. Examples of client-emulating gateways are provided above. Step 704 receives a communication, from a first user, in accordance with a first protocol. Any suitable type of communication can be received. In at least some embodiments, the communication can reside in the form of a call. Alternately or additionally, the communication can reside in the form of an instant message. Other types of communications can be received without departing from the spirit and scope of the claimed subject matter. In addition, any suitable protocol can serve as the first protocol.

Step 706 translates data of the communication into a second protocol associated with a second user. The second user is the intended recipient of the communication and uses the second protocol for its originated and received communications. Any suitable type of translation can be utilized. For example, in at least some embodiments, translation occurs by translating audio packets formatted in accordance with the first protocol into audio packets formatted in the second protocol. Alternately or additionally, translation can occur by using APIs, internal to the client-emulating gateway, to translate data associated with the communication at the protocol level.

Step 708 sends the translated communications data in the second protocol to an end user terminal associated with the second user. This step can be performed in any suitable way.

Step 710 receives a communication, from the second user, in accordance with the second protocol. This communication may be a reply to the translated communication sent by step 708. Step 712 translates data of the communication into the first protocol associated with the first user. Step 714 sends the translated communications data in the first protocol to an end user terminal associated with the first user. These steps can be performed in a similar manner as was described with respect to steps 704, 706, and 708.

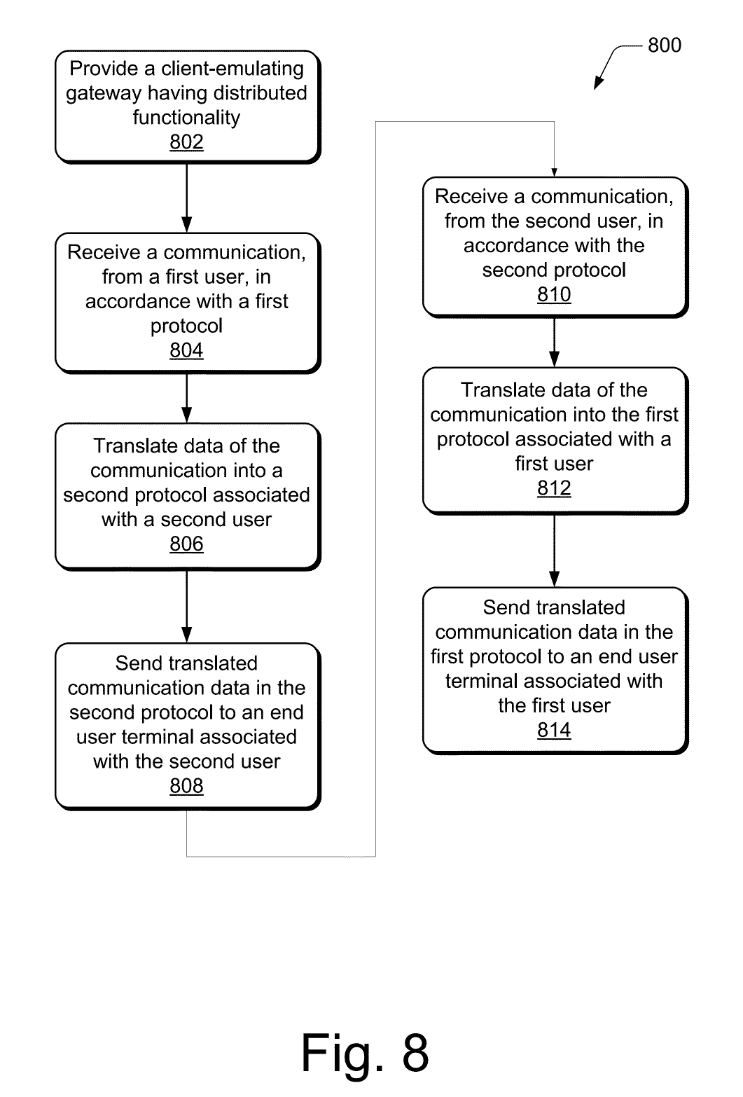

FIG. 8 illustrates a method 800 in accordance with one or more embodiments. The method can be implemented in connection with any suitable hardware, software, firmware, or combination thereof. In at least some embodiments, the method can be implemented by a suitably-configured client-emulating gateway as described above.

Step 802 provides a client-emulating gateway having distributed functionality. An example of a client-emulating gateway having distributed functionality is provided above. Step 804 receives a communication, from a first user, in accordance with a first protocol. Any suitable type of communication can be received. In at least some embodiments, the communication can reside in the form of a call. Alternately or additionally, the communication can reside in the form of an instant message. Other types of communications can be received without departing from the spirit and scope of the claimed subject matter. In addition, any suitable protocol can serve as the first protocol. This step can also include forwarding the communication to a distributed component that is responsible for handing the particular type of communication.

Step 806 translates data of the communication into a second protocol associated with a second user. In one or more embodiments, this can be performed by using components of the client-emulating gateway that have been distributed. In operation, components that are configured for a particular aspect of a type of communication can be utilized, while other components that are not utilized for the particular aspect of the communication type are not utilized. For example, a network transport can receive the communication and then forward the communication to a component that is configured to handle that aspect of the communication type, e.g., a component that handles communication of presence information, a calling component, an instant messaging component and the like.

Step 808 sends the translated communications data in the second protocol to an end user terminal associated with the second user.

Step 810 receives a communication from the second user in accordance with the second protocol. This communication can be a reply to the translated communication data that was sent by step 808. This step can also include forwarding the communication to a distributed component that is responsible for handing the particular type of communication.

Step 812 translates data of the communication into the first protocol associated with the first user. An example of how this can be done is provided above. Step 814 sends translated communications data in the first protocol to an end user terminal associated with the first user.

The methods described in FIGS. 7 and 8 can, through the use of the client-emulating gateway, enable clients on different types of network to communicate with one another using their own protocol. Translation, as between protocols, is transparent to the clients such that the clients perceive no change in the manner in which they send or receive communications.

Having considered example methods in accordance with one or more embodiments, consider now an example system and aspects of other devices or end user terminals that can be utilized to implement the embodiments described above.

### Example System

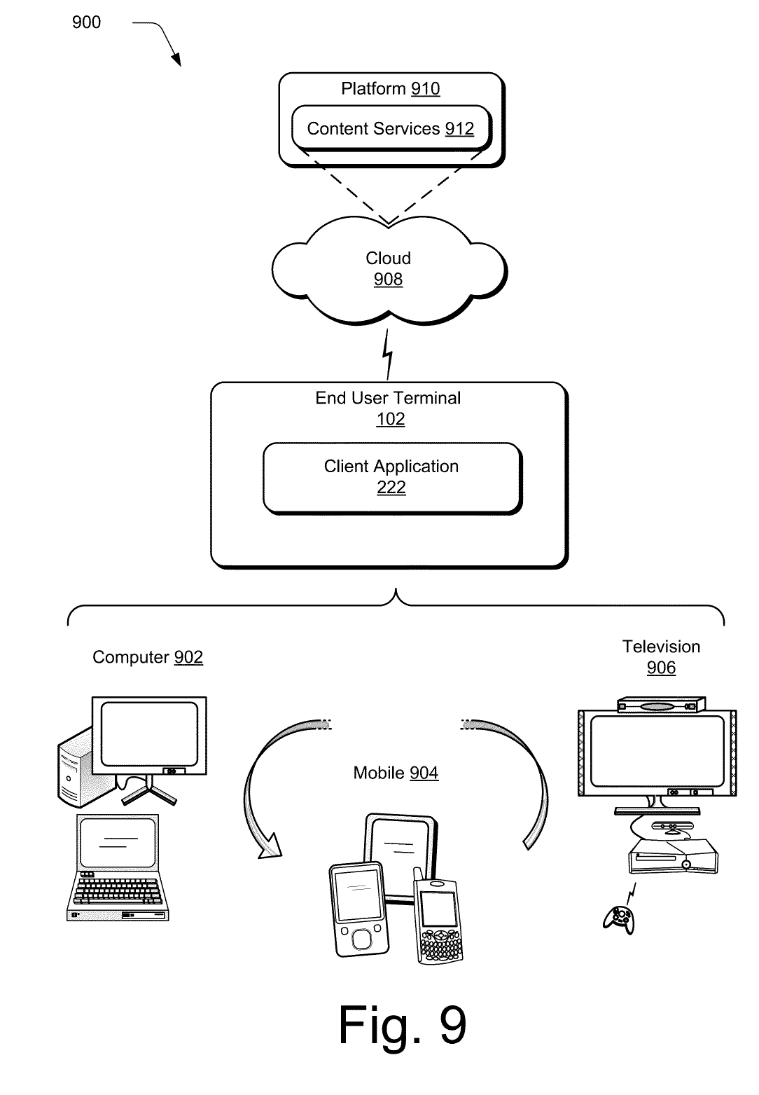

FIG. 9 illustrates an example system 900 that includes the end user terminal 102 as described with reference to FIG. 1. The example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that implement a client-emulating gateway as described above. These computers can be connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the end user terminal 102 may assume a variety of different configurations, such as for computer 902, mobile 904, and television 906 uses. Each of these configurations includes devices that may have generally different constructs and capabilities, and thus the end user terminal 102 may be configured according to one or more of the different device classes. For instance, the end user terminal 102 may be implemented as the computer 902 class of a device that includes a personal computer, desktop computer, a multi-screen computer, laptop computer, netbook, and so on. Each of these different configurations may employ the techniques described herein, as illustrated through inclusion of the client application 222 which can serve to enable a user to make calls and participate in other communications, as described above.

The end user terminal 102 may also be implemented as the mobile 904 class of device that includes mobile devices, such as a mobile phone, portable music player, portable gaming device, a tablet computer, a multi-screen computer, and so on. The end user terminal 102 may also be implemented as the television 906 class of device that includes devices having or connected to generally larger screens in casual viewing environments. These devices include televisions, set-top boxes, gaming consoles, and so on. The techniques described herein may be supported by these various configurations of the end user terminal 102 and are not limited to the specific examples the techniques described herein.

The cloud 908 includes and/or is representative of a platform 910 for content services 912. The platform 910 abstracts underlying functionality of hardware (e.g., servers) and software resources of the cloud 908. The content services 912 may include applications and/or data that can be utilized while computer processing is executed on servers that are remote from the end user terminal 102. Content services 912 can be provided as a service over the Internet and/or through a subscriber network, such as a cellular or Wi-Fi network.

The platform 910 may abstract resources and functions to connect the end user terminal 102 with other computing devices. The platform 910 may also serve to abstract scaling of resources to provide a corresponding level of scale to encountered demand for the content services 912 that are implemented via the platform 910. Accordingly, in an interconnected device embodiment, implementation of functionality described herein may be distributed throughout the system 900. For example, the functionality may be implemented in part on the end user terminal 102 as well as via the platform 910 that abstracts the functionality of the cloud 908.

### CONCLUSION

Various embodiments provide a client-emulating gateway that is configured to emulate a first client that communicates using a first protocol. The client-emulating gateway receives communications from a second client in accordance with a second, different protocol used for communicating by the second client. The client-emulating gateway then translates the communications from the second, different protocol to the first protocol to provide translated communications. The translated communications are then sent to the first client using the first protocol. Communications that are received back from the first client in the first protocol are then translated into the second, different protocol and then sent to the second client.

In at least some embodiments, scalability is promoted by utilizing a distributed client-emulating gateway. In these embodiments, various functionality utilized by clients to communicate is distributed and run separately. By distributing functionality, information and data that is not utilized in a current communication can be stored and reloaded, as necessary, when needed for a particular communication.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
providing a client-emulating gateway configured to emulate a plurality of clients and translate communications from clients in a first protocol to communications in at least a second protocol;
receiving a communication from a first user in accordance with a first protocol;
translating data of the communication into the second protocol, the second protocol being associated with a second user; and
sending translated communication data in the second protocol to an end-user terminal associated with the second user.

2. The method of claim 1, wherein said receiving a communication comprises receiving a call.

3. The method of claim 1, wherein said receiving a communication comprises receiving a communication other than a call.

4. The method of claim 1, wherein said translating comprises translating audio packets formatted in accordance with the first protocol into audio packets formatted in the second protocol.

5. The method of claim 1, wherein said translating comprises using application program interfaces (APIs) internal to the client-emulating gateway.

6. The method of claim 1, wherein the first protocol is a peer-to-peer protocol.

7. A computer-implemented method comprising:
providing a client-emulating gateway having distributed functionality, the client-emulating gateway being configured to emulate a plurality of clients and translate communications from clients in a first protocol to communications in at least a second protocol;
receiving a communication from a first user in accordance with a first protocol;
translating data of the communication into the second protocol, the second protocol being associated with a second user; and
sending translated communications data in the second protocol to an end-user terminal associated with the second user.

8. The method of claim 7, wherein said receiving a communication comprises receiving a call.

9. The method of claim 7, wherein said receiving a communication comprises receiving a communication other than a call.

10. The method of claim 7, wherein said receiving a communication further comprises forwarding the communication to a distributed component that is responsible for handling a particular type of communication.

11. The method of claim 7, wherein said receiving a communication is performed by a network transport configured to receive the communication and forward the communication to another distributed component.

12. The method of claim 7, wherein said receiving a communication further comprises forwarding the communication to a distributed calling component that is responsible for handling the communication.

13. The method of claim 7, wherein said receiving a communication further comprises forwarding the communication to a distributed presence component that is responsible for handling the communication.

14. The method of claim 7, wherein said receiving a communication further comprises forwarding the communication to a distributed instant messaging component that is responsible for handling the communication.

15. One or more computer readable storage media embodying computer-readable instructions which, when executed, implement a system comprising:
a client-emulating gateway configured to:
emulate a plurality of clients;
receive communications from clients intended for other clients, and
translate the communications from protocols in which the communications are received to protocols in which the intended clients communicate.

16. The one or more computer readable storage media of claim 15, wherein at least one of the protocols comprises a peer-to-peer protocol.

17. The one or more computer readable storage media of claim 15, wherein the client-emulating gateway comprises distributed functionality comprising at least a distributed network transport and at least one other component associated with a communication type.

18. The one or more computer readable storage media of claim 15, wherein the client-emulating gateway comprises distributed functionality comprising at least a distributed network transport and at least a distributed presence component.

19. The one or more computer readable storage media of claim 15, wherein the client-emulating gateway comprises distributed functionality comprising at least a distributed network transport and at least a distributed calling component.

20. The one or more computer readable storage media of claim 15, wherein the client-emulating gateway comprises distributed functionality comprising at least a distributed network transport and at least a distributed presence component, a distributed calling component, and a distributed instant messaging component.
